(19) United States
(12) Patent Application Publication
(10) Pub. No.: US 2008/0071626 A1
(43) Pub. Date: Mar. 20, 2008

(54) SYSTEMS AND METHODS FOR EVENT-BASED AUTOMATED CONSUMABLE REORDERING

(76) Inventor: Evan M. Hill, Sandy, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 11/561,722

(22) Filed: Nov. 20, 2006

Related U.S. Application Data
(60) Provisional application No. 60/826,293, filed on Sep. 20, 2006.

(51) Int. Cl. G06Q 10/00

(52) U.S. Cl. 705/22

(57) ABSTRACT

Reordering consumables for office machines such as computer printers, fax machines, and copiers includes monitoring a consumable level, determining that the consumable level is at or below a threshold, establishing a connection to the Internet and/or opening a web browser, and at least partially completing an online form for the consumable. In one embodiment, a combined order is automatically generated that includes a plurality of different consumables. In addition, or in another embodiment, a consumable management portal searches a plurality of vendor websites for a replacement consumable and presents a price comparison to a user. The user is allowed to selectively place an order with one or more of the plurality of vendors.

### RELATED APPLICATION

This application claims the benefit under 35 U.S.C. §119(e) of U.S. Provisional Application No. 60/826,293, filed Sep. 20, 2006, which is hereby incorporated by reference herein in its entirety.

### TECHNICAL FIELD

The present disclosure relates generally to office machines, such as computer printers, fax machines, and copiers, and more specifically, to systems and methods for simplifying the reordering of consumables for office machines.

### BRIEF DESCRIPTION OF THE DRAWINGS

Non-limiting and non-exhaustive embodiments of the disclosure are described, including various embodiments of the disclosure with reference to the figures, in which:

FIG. 1 is a schematic block diagram of a system for automated or semi-automated consumable ordering according to one embodiment;

FIG. 2 is a schematic block diagram of a system for automated or semi-automated consumable ordering according to another embodiment;

FIG. 3 is a flowchart of a method for automated or semi-automated consumable ordering according to one embodiment;

FIG. 4 is a schematic block diagram of a system for automated or semi-automated consumable ordering according to another embodiment;

FIG. 5 is a block diagram of a module for ordering consumables according to one embodiment;

FIG. 6 is a block diagram of a consumable management portal according to one embodiment;

FIG. 7 is a general representation of a computer user interface for ordering consumables according to one embodiment;

FIG. 8 is a flowchart of a method for ordering a plurality of consumables according to one embodiment;

FIG. 9 is a block diagram of an exemplary data structure for an order of consumables according to one embodiment;

FIG. 10 is a block diagram of an exemplary data structure for a plurality of orders of consumables according to one embodiment; and

FIG. 11 is flowchart of a method for replenishing a local consumable inventory according to one embodiment.

### DETAILED DESCRIPTION

Office machines include, for example, printers, copiers, fax machines, combinations of the foregoing, and other devices that use consumables such as ink, toner, paper, or staples. Printers, for example, may be for home or office use and come in a wide variety of brands and models, many of which require different types of consumables, such as specialized ink cartridges or specialized paper. Many printers require multiple cartridges corresponding to different colors (e.g., black, cyan, magenta, yellow). Thus, literally hundreds of different types of ink cartridges are available. Further, some printers and/or other office machines require paper of a particular composition or with special coatings in order to maximize the quality of the printing.

When one or more consumables within an office machine is exhausted, a user is faced with the daunting task of reordering the correct consumables for that office machine. Unfortunately, even if the user remembers the model number of the office machine and/or consumables, a warning by the office machine that the consumables have been exhausted typically occurs too late for the average user. Unless the user maintains a supply of replacement consumables, any project the user is working on may have to be deferred until new consumables are purchased.

From the perspective of an office machine manufacturer, consumables are typically seen as an opportunity for the manufacturer to recoup subsidies on the cost of the office machine. For example, a general business model in the printer industry includes selling printer hardware at or below cost, and relying on consumable sales for profitability. However, in response to high consumable costs, an aftermarket industry has arisen specializing in “compatible” or “refilled” toner and ink cartridges. Typically, these compatible or refilled cartridges are not of the same quality as the original products made by the manufacturer, often resulting in low quality output, clogged inkjet heads, and the like. Consumers often blame the printer manufacturer and seek warranty repairs, which adds further costs to the manufacturer.

Printer manufacturers have responded to this challenge, for example, with technical countermeasures to prevent the use of compatible or refilled consumables and have recently resorted to lawsuits under the Digital Millennium Copyright Act (DMCA). However, these responses have generally been unsuccessful. Accordingly, what is needed is a way for office machine manufacturers and/or consumable vendors to encourage office machine owners to purchase quality consumables, while providing a service to office machine owners that simplifies the process of reordering office machine consumables with sufficient lead time to avoid shortfalls.

The embodiments of the disclosure will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

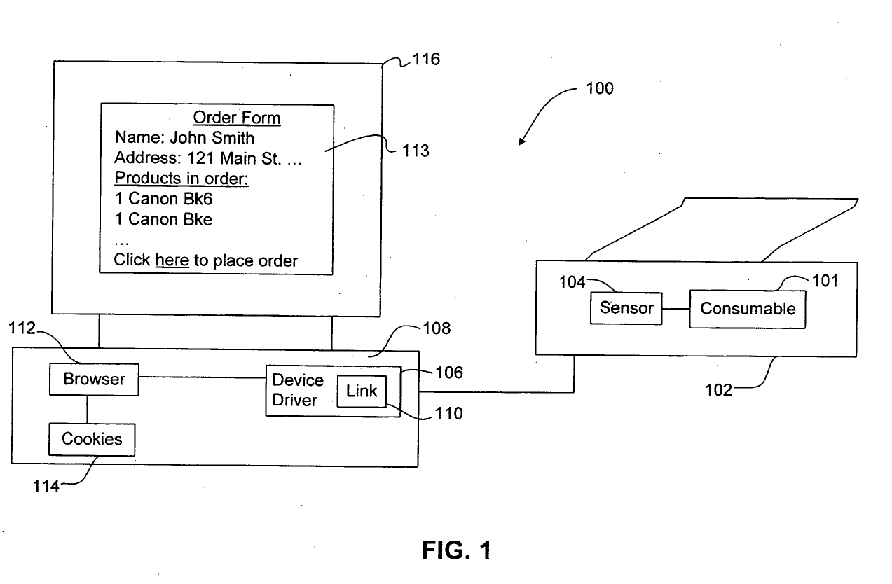

FIG. 1 is a schematic block diagram of a system 100 for automated or semi-automated ordering of a consumable 101 for an office machine 102 according to one embodiment. The consumable 101 is compatible with the office machine 102 and may comprise, for example, printer ink, toner, one or more printer cartridges, paper, specialized paper, or staples. An artisan will recognize from the disclosure herein that the office machine 102 may include more than one consumable 101. For example, the office machine 102 may comprise a combination printer/copier that uses a particular toner, specialized paper, and staples.

In the embodiment shown in FIG. 1, the office machine 102 includes one or more sensors 104 (one shown) to detect a particular event, such as a consumable 101 within the office machine 102 reaching a low level or a level below a threshold defined by the office machine 102 or a user. For example, the sensor 104 may determine a low ink level in one or more ink reservoirs (not shown) in the office machine 102. As another example, the sensor 104 may determine that the paper supply in the office machine is low or completely consumed in one or more paper input trays. An artisan will recognize that certain embodiments disclosed herein may be practiced without using a sensor that measures physical parameters of the consumable 101. For example, determination that the consumable 101 has reached a low level may be based on tracking factors such as the number of pages printed since the consumable was first used or replaced and/or the size of documents printed (e.g., in pages or bytes).

Upon determining that the amount or level of the consumable 101 is low, the office machine 102 notifies a device driver 106, according to one embodiment, within a computer 108 or the like. The device driver 106 comprises a software interface for communicating with the office machine 102 through, for example, a specific computer bus or communications subsystem (not shown). Thus, the device driver 106 provides commands to and/or receives data from the office machine 102. The device driver 106 provides an interface to an operating system within the computer and may also provide software applications to perform the processes described herein or specific to the functionality of the office machine 102 (e.g., printing). The device driver 106 may, for example, be included with the sale of the office machine 102, or may be sold and installed later for use in connection with an existing office machine 102. For example, the device driver 106 may be downloaded from a printer manufacturer or aftermarket supplier of consumables.

The computer 108 may be a single-processor or multiprocessor machine and may include memory having the device driver 106 and other software modules or coded instructions for performing the processes described herein. For example, the computer 108 may be a personal computer, workstation, server, mini-computer, hand-held computer, main-frame computer, mobile computer, set top box for a television, computing devices integrated into other hardware, combinations thereof, or the like.

In one embodiment, the device driver 106 includes a link 110, such as a uniform resource locator (URL) or the like, that the device driver 106 uses to automatically direct a web browser 112 to an order form 113 on the office machine manufacturer's (or a consumable vendor's) website. A user may then use the browser to purchase the particular type of consumable 101 that the office machine 102 requires, or that the user desires to purchase for use with the office machine 102, from the website. In another embodiment, the order form 113 is stored in the memory of the computer 108 and may be accessed through the browser 112 or another software application stored in the memory. In such an embodiment, data may be provided to the order form 113 for later transmission to the website. For example, at least part of the data for ordering the consumable may be provided to the order form 113. Then, when the computer 108 has access to the website, the device driver 106 may direct the browser 112 to send the order form 113, or portions of its data, to the website.

In one embodiment, the device driver 106 automatically provides data through the browser 112 to the order form 113 corresponding to the particular product required by the office machine 102 or preferred by the user. For example, in the case of printer ink, the printer driver 106 may identify a particular color of ink cartridge that is low and provide a unique product number or identifier for the ink cartridge to the order form 113. As such, the user need not review manuals, or otherwise conduct research, in order to determine the product number for the ink cartridge that needs to be replaced.

What may constitute a low-consumable event may vary from situation to situation. For example, if the office machine 102 typically prints or copies approximately 1000 pages during the course of a typical week, determining that the office machine's toner is approximately 75% consumed might be considered a low toner condition. On the other hand, if the office machine 102 typically prints or copies approximately ten pages in a week, the same toner might last for months. Accordingly, in one embodiment, a user may explicitly define what is considered to be a low-consumable condition.

For example, the user may select a setting for reordering the consumable 101 when the office machine 102 is estimated to print or copy approximately 100 pages before running out of the consumable 101. When the device driver 106 detects this condition (e.g., an estimate that approximately 100 pages may be printed before running out of ink), an indication may be displayed to the user via the browser 112. The indication may be displayed, for example, in a pop-up message or in other ways. The indication may state, for example, “100 Pages Before Ink Reservoir X is Empty—Click here to place a reorder.” Upon receiving an indication that a user has clicked on the link, the web browser 112 may automatically display the order form 113, place the order, and/or present the user with other options, as described herein.

In addition, or in another embodiment, the office machine 102 and/or device driver 106 tracks typical usage and dynamically sets the criteria for a low-consumable condition. Order processing and shipping times may be taken into account in determining how much lead time to provide to the user. For example, if the user typically prints approximately 100 pages per day, and the average shipping time for the consumable 101 (or an estimated current shipping time as provided by the website) is approximately 3 days, then the user could be notified at approximately the time when enough of the consumable 101 remains to print approximately 300-400 pages.

The system 100 may be configured to not only direct the web browser 112 to the order form 113 for the consumable 101 that is needed, but may also be configured to automatically fill in the order form 113 with relevant customer, shipping, and/or billing information. For example, in some embodiments, the web browser 112 may access cookies 114 or other stored information previously received from the user. An artisan will understand from the disclosure herein that “filling in” an order form does not necessarily mean providing or displaying a form (such as the order form 113) that is at least partially completed. Rather, an order form may be filled in by providing information used to complete an order, whether or not a form is displayed or otherwise provided to a user. Further, for example, portions or fields of an order form may be displayed (e.g., product number) without displaying other portions or fields of the order form (e.g., name, address, or billing information).

Upon installing the office machine 102 and/or registering the device driver 106 or other software, for example, the user may be prompted for information that may be needed to at least partially complete an order for office machine consumables 101, such as names, addresses, credit card numbers, and other user-specific information. The computer 108 may store the information in one or more cookies 114 that the browser 112 later uses to automatically fill an appropriate order form 113 that is generated upon detecting, for example, that one or more ink reservoirs is low.

Because some users may want to approve orders before they are transmitted, some embodiments may be configured such that the order is nearly complete and need only be reviewed and executed by the user to finish placement of the order. Of course, in other embodiments, the user may be responsible for filling in certain pieces of information prior to finalization of the order placement. For example, a user may be uncomfortable with the idea of storing a credit card number for automated ordering, and this information may therefore be left blank and filled in manually by such a user prior to transmission of the order to the selected vendor. However, as discussed below, in other embodiments, the device driver 106 may be configured to order the consumable 101 without any user intervention.

As discussed in detail below, some embodiments also provide for an automated shopping comparison for reordering a consumable 101. For example, the system 100 may be configured to display prices for printer ink from a plurality of different retailers/vendors to allow comparison shopping. The user may then review the prices and other relevant information for each of the various vendors and choose one, for example, by clicking a link associated with the desired vendor. The system 100 may be configured such that clicking on the desired link causes an order form 113 for the desired vendor to be automatically generated and filled in with one or more pieces of information needed to complete the order. In some embodiments, an order form 113 may be automatically generated for each of the various vendors that are represented in the shopping comparison. Each order form 113 may then be stored in memory and will be immediately available upon receiving an indication that the user has selected one of the vendors in the comparison.

In still other embodiments, the office machine 102 may be configured to automatically print a list of the consumables 101 that will shortly run out. The list may include, for example, model numbers, stock numbers (e.g., specific to a particular vendor), barcodes, combinations of the foregoing, and/or other indicators to allow a vendor to quickly identify the correct consumable 101.

The list also includes, in one embodiment, an indication of one or more stores at which the consumable 101 may be purchased. The indication may include the names and addresses of one or more stores, as well as maps and directions based on the user's location. In certain embodiments, only stores in which the consumables 101 are currently in stock may be listed.

The list also includes, in one embodiment, an indication of one or more service providers or notification of a service provider that the consumable 101 may need to be replaced. The indication may include the names, addresses and contact information of one or more local service providers based on the user's location. In certain embodiments, the service provider may be notified directly or the user may be directed to a website to accept or decline ordering replacement consumables 101 from a service provider.

Included with the list may be incentives, such as printed coupons, that will provide a discount to the user for purchasing the consumables 101 from a certain vendor or simply purchasing original ink from the manufacturer as opposed to compatible or refilled ink. Various other incentives, such as clubs in which the user receives points for purchasing ink from particular vendors or directly from the office machine manufacturer, may be provided.

As discussed below, other embodiments may be configured for use in network environments wherein a plurality of office machines 102 and/or computers 108 are present. In such embodiments, reordering of consumables 101, such as printer ink, for the entire network may be automated as described above. Thus, a single order may be automatically created upon detecting that any of the office machines 102 in the network have one or more ink reservoirs that are low or empty.

In addition, or in another embodiment, composite orders may be generated on an intermittent basis for all of the different types of ink, toner, or other consumables that are required. For example, the system 100 may be configured to automatically generate an appropriate order form 113 once per month. At the desired time(s) during the month, ink reservoir levels may be checked and any that fall below a threshold level may be included in the composite order. In this way, a network administrator or office supplies administrator, for example, can satisfy the refill needs of each of the office machines in the network without manually placing refill orders on an ad hoc basis, regardless of how many different office machine types may be present in the network.

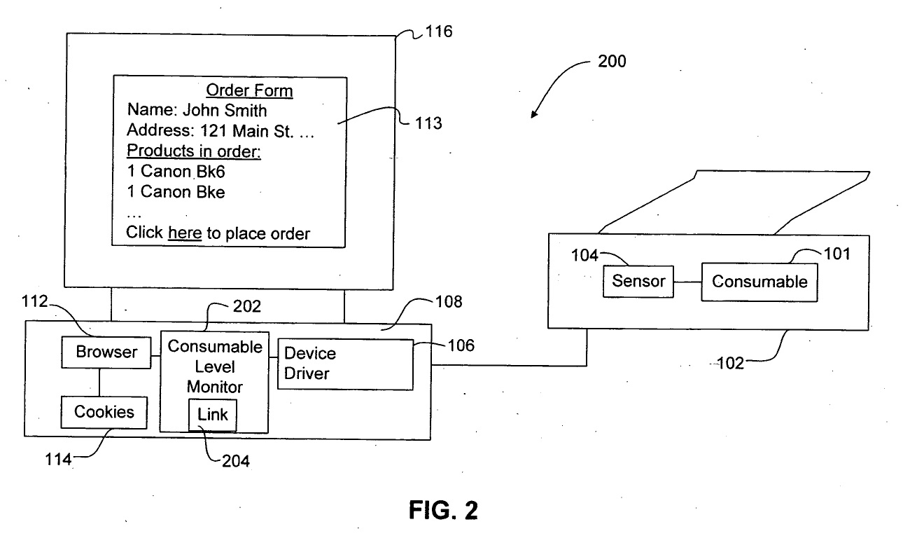

FIG. 2 is a schematic block diagram of a system 200 for automated or semi-automated consumable ordering according to another embodiment. In the embodiment shown in FIG. 2, the computer 108 includes a standalone consumable level monitor 202 to monitor the level of the consumable 101 within the office machine 102. In one embodiment, the consumable level monitor 202 communicates directly with the device driver 106 to monitor the level of the consumable 101. In another embodiment, the consumable level monitor 202 directly reads status information from the sensor 104 within the office machine 102. The consumable level monitor 202 includes or has access to a link 204 or other mechanism for directing the web browser 112 to the order form 113, as discussed above in connection with FIG. 1.

In one embodiment, the consumable level monitor 202 comprises a software module that may be purchased and/or installed in the memory of the computer 108 separately from the device driver 106. Thus, the consumable level monitor 202 may be provided by the manufacturer of the office machine 102, a vendor of the consumable 101, and/or a service provider so as to provide the processes described herein for existing office machines and/or printer drivers. For example, an ink cartridge vendor that is not interested in providing complete printer drivers may provide the consumable level monitor 202 to users of ink jet printers so as to encourage the users to purchase replacement ink cartridges from the vendor.

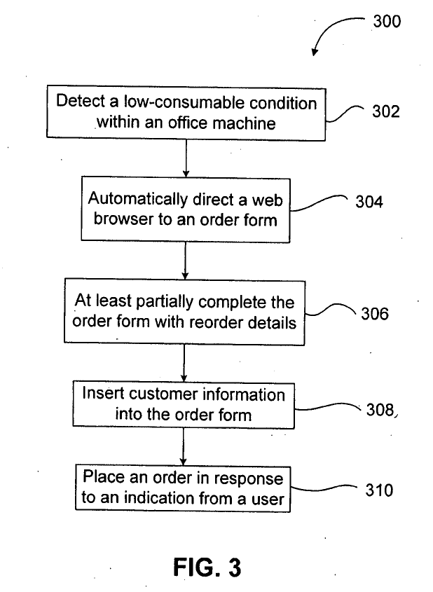

FIG. 3 is a flowchart of a method 300 for automated or semi-automated consumable ordering according to one embodiment. The method 300 includes detecting 302 a low-consumable condition or event within an office machine. As discussed above, the low-consumable condition may be detected by a sensor within the office machine. The sensor may send details of the condition, including what consumables need to be replaced, to a device driver located in a computer in communication with the office machine. In some embodiments, the sensor may send the details directly to a management information system for evaluation by a system administrator. In another embodiment, detecting the low-consumable condition or event comprises tracking information (e.g., number of pages printed/copied, number of bytes sent to the office machine for printing, etc.) sent between a device driver and the office machine. In one embodiment, a separate consumable level monitor determines that a low-consumable condition exists by monitoring communications between the device driver and the office machine.

The method 300 also includes automatically directing 304 a web browser to an order form for placing an order for the consumables. The device driver (or a separate consumable level monitor) may use a link, for example, to automatically direct the web browser to a website hosting the order form. As discussed above, in another embodiment, the browser accesses the order form from a file stored on a local computer.

In one embodiment, the method 300 continues by at least partially completing 306 the order form with reorder details. The reorder details may include, for example, an indication of the required consumables; office machine type, model number or code; and/or consumable product type, color, number or code. In one embodiment, the method 300 continues with inserting 308 customer information into the order form. As discussed above, adding the reorder details and the customer information into the order form does not necessarily mean displaying all or a portion of the reorder details and/or customer information. The customer information may include, for example, name, address, credit card information, account information, shipping information, combinations of the foregoing, and/or other information useful for completing the order. The customer information may be retrieved, for example, from one or more cookies. The method may conclude by placing 310 an order in response to an indication from the user. In one embodiment, the consumable is automatically added to an online shopping cart such that the user need only submit the order. For example, the user may click on a “Place Order” button or the like.

Of course, it should be understood that the presentation to the user may vary considerably as desired. For example, the order form 113 need not be automatically generated and presented to the user upon detecting a low/empty consumable level. Instead, a message may be generated for the user and presented on a computer monitor 116 (see FIG. 1). The message may include a link that, when followed, automatically generates the appropriate order form 113 and/or fills in one or more pieces of relevant information.

For example, upon detecting an ink reservoir that is low, the office machine 102 may send a message to the computer 108. The computer 108 may then generate a message that is displayed on the monitor 116. The message might say, “Low Ink Level Detected—Click here to see pricing and ordering options.” Upon clicking on the link, a website with the appropriate order form 113 may be displayed, filled in with one or more pieces of the reorder details and the customer information (e.g., from the cookies 114 or elsewhere), and presented to the user for confirmation. Alternatively, clicking the link may generate a comparison shopping list, as described herein. The user may then click on a secondary link associated with the chosen vendor for placing the reorder and the order form 113 may then be generated and displayed to the user.

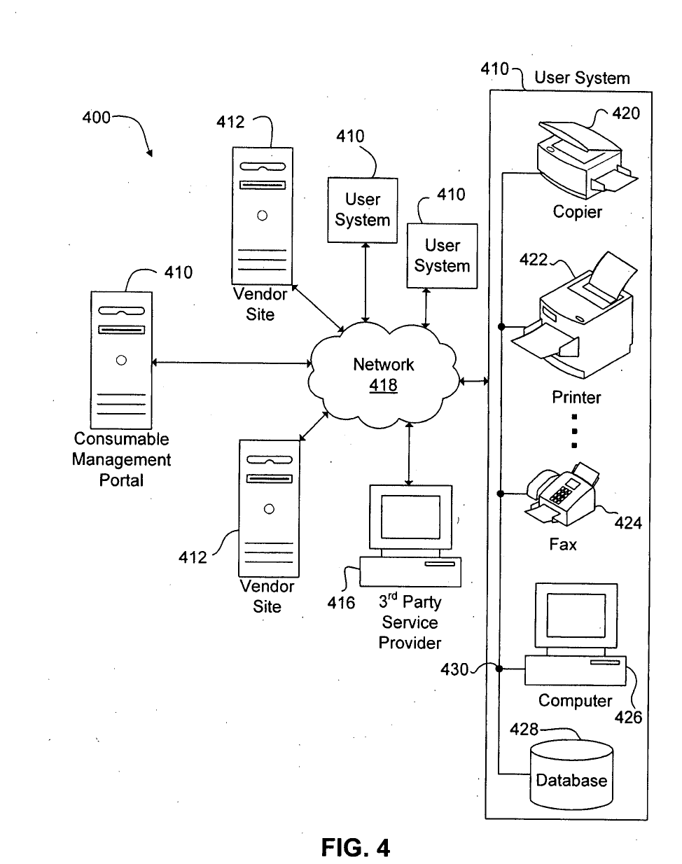

FIG. 4 is a schematic block diagram of a system 400 for automated or semi-automated consumable ordering according to another embodiment. The system 400 includes one or more user systems 410 (three shown), one or more vendor sites 412 (two shown), a consumable management portal 414, and a third party service provider system 416 in communication with one another through a network 418. The network 418 may include, for example, the Internet or World Wide Web, an intranet such as a local area network (LAN) or a wide area network (WAN), a public switched telephone network (PSTN), a cable television network (CATV), or any other network of communicating computerized devices. As used herein, “a network” may include one or more interconnected networks. For example, communication between a computer and a website through a network may include communication through a LAN and a WAN.

For illustrative purposes, one of the user systems 410 is shown to include a copier 420, a printer 422, a fax machine 424, a computer 426, and a database 428 interconnected through a LAN 430. An artisan will recognize from the disclosure herein that one or more of the copier 420, the printer, and the fax machine 424 may be combined in a single office machine and that other office machines may also be connected to the LAN 430. The database 428 stores, for example, user information, billing information, shipping information, consumable preferences, vendor preferences, consumable threshold levels, inventory threshold levels, local inventory contents, combinations of the foregoing, and other information discussed herein.

The computer 426 may be used, for example, by a network administrator or office supplies administrator to monitor and order consumables used by the copier 420, the printer 422, and the fax machine 424. In addition, or in other embodiments, the system 416 may be used by a third party service provider to monitor and order consumables used by the copier 420, the printer 422, and the fax machine 424. For example, users of one or more user systems 410 may outsource consumable management tasks to an office supply management company that tracks, monitors, reorders, refills, and/or restocks consumables for the user systems 410.

The computer 426 and/or the third party service provider system 416 may include one or more device drivers, as discussed above, to communicate with one or more of the copier 4420, the printer 422, and the fax machine 424. In some embodiments, the computer 426 and/or the third party service provider system 416 also includes a separate consumable level monitor, as discussed above. In one embodiment, the user system 410 includes one or more consumable level monitors that collect and provide consumable status information to the third party service provider system 416.

The vendor sites 412 comprise web portals that provide one or more order forms to the user systems 410 and/or the third party service provider system 416. Different order forms are provided for each different type of consumable. However, in one embodiment, a vendor site 412 provides a single order form for a plurality of different consumable types. As discussed above, the order forms may be used to automatically or semi-automatically reorder consumables for the copier 420, the printer 422, and the fax machine 424. Further, the device drivers and/or separate consumable level monitors may partially complete the order forms with reorder details and/or customer information.

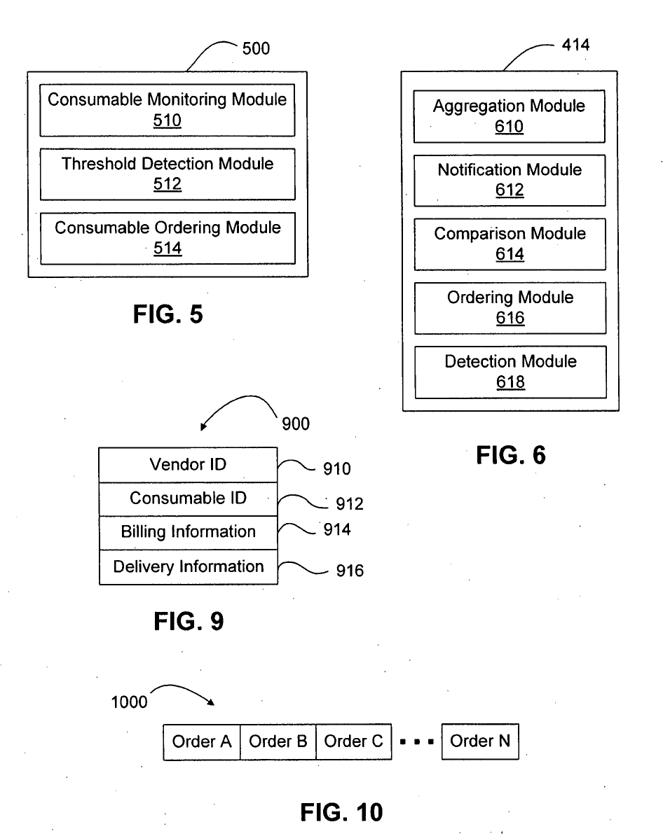

FIG. 5 is a block diagram of a module 500 for ordering consumables according to one embodiment. The module 500 is usable, for example, by the device drivers and/or separate consumable level monitors in the user systems 410 or the third party service provider system 416. The module 500 includes a consumable monitoring module 510, a threshold detection module 512, and a consumable ordering module 514.

The consumable monitoring module 510 monitors, through the LAN 430 and/or the network 418, consumable levels for the copier 420, the printer 422, and the fax machine 424. The consumable monitoring module 510 may receive data from sensors and/or may track parameters such as the number of pages printed since a particular consumable was last replaced.

The threshold detection module 512 determines whether a particular consumable for a particular subset of office machines is at or below a predetermined threshold level. For example, if the copier 420 and the printer 422 use the same specialized paper, the threshold detection module 512 may be configured to detect when a supply of the specialized paper has been reduced to or below a threshold level (e.g., 500 sheets) through combined use of the copier 420 and the printer 422. The threshold level may be specified by a user. In addition, or in another embodiment, the threshold detection module automatically determines the threshold level based on historical usage patterns.

The consumable ordering module 514 generates one or more orders for consumables with levels at or below the threshold level. In one embodiment, the consumable ordering module 514 generates a combined order for a plurality of consumables that are at or below respective threshold levels. In certain embodiments, the consumable ordering module 514 automatically submits the generated order to a vendor site 412 without user intervention. For example, the consumable ordering module 514 may automatically open a web browser, direct the web browser to a particular vendor site 412, fill in an order form on the particular vendor site 412, and submit the order form. In other embodiments, the consumable ordering module 514 allows the user to approve the order and submit the approved order to the particular vendor site 412. For example, the consumable ordering module 514 may automatically add the consumables to a shopping cart, along with billing information and delivery information, and allow the user to submit the order in the shopping cart with a single action.

Returning to FIG. 4, the consumable management portal 414 allows the user systems 410 and/or the third party service provider system 416 to comparison shop for consumables available from a number of different vendor sites 412. FIG. 6 is a block diagram of the consumable management portal 414 according to one embodiment. The consumable management portal 414 includes an aggregation module 610, a notification module 612, a comparison module 614, an ordering module 616, and a detection module 618.

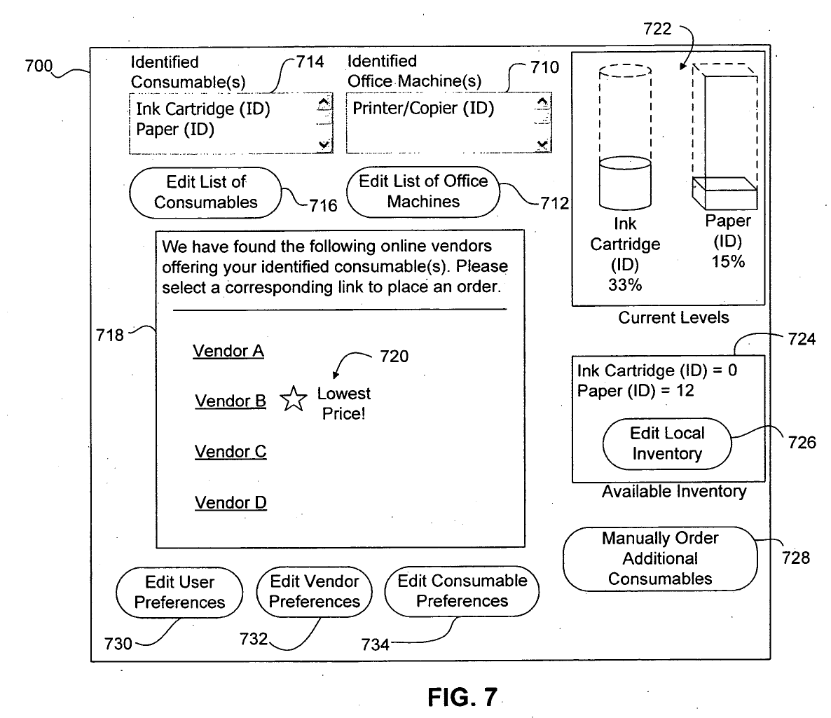

The aggregation module 610 combines information received through the LAN 430 and/or the network 418 regarding consumable levels for the copier 420, the printer 422, the fax machine 424 and any other office machines in the user system 410. The notification module 612 displays a summary of the consumable levels to a user. In one embodiment, the summary is by way of a graphical display representing a remaining percentage of a supply of a particular consumable. Such a display is discussed in detail below with respect to FIG. 7.

The comparison module 614 searches the vendor sites 412 for offers of particular consumables. If pricing information is available, the comparison module 614 displays to the user a list of prices from the different vendor sites 412 offering the particular consumables. Thus, the user can compare prices before deciding to order the particular consumables. The ordering module 616 allows the user to place an order for the particular consumables. In one embodiment, the ordering module 616 allows the user to place a combined order for particular consumables used by at least two of the copier 420, the printer 422, and the fax machine 424.

The detection module 618 determines whether a particular consumable for a particular subset of office machines is at or below a predetermined threshold level. The threshold level may be specified by a user. In addition, or in another embodiment, the threshold detection module automatically determines the threshold level based on historical usage patterns. In one embodiment, the ordering module 616 is configured to automatically add an indication of a particular consumable having a level at or below the threshold level to an order.

FIG. 7 is a general representation of a computer user interface 700 for ordering consumables according to one embodiment. The user interface 700 is usable, for example, by the consumable management portal 414 shown in FIG. 4. The user interface 700 displays a list of one or more identified office machines 710 that are monitored for consumable levels. The user interface 700 allows a user to select a button 712 to edit the list of office machines being monitored. As shown in FIG. 7, each of the office machines may be associated with a unique identifier (ID). The office machine ID may include, for example, the office machine manufacturer's model number for the particular office machine.

The user interface 700 also displays a list of one or more identified consumables 714 having levels that are being monitored (e.g., by the consumable monitoring module 510). Again, the user interface 700 allows a user to select a button 716 to edit the list of consumables being monitored. As shown in FIG. 7, each of the consumables may be associated with a unique ID that may include, for example, the consumable manufacturer's model number for the particular consumable.

The user interface 700 also displays a comparison 718 of a number of different vendors (e.g., vendors A, B, C, and D) offering the identified consumables 714. In one embodiment, the displayed vendor names include links and the user is allowed to direct a web browser to the website (not shown) of a particular vender (e.g., vendor A) by clicking on the vendor's name. By following the link, the web browser may be directed to a search results page of the selected vendor's site displaying the results of an automatic search for the consumables. The search results page may include an order form at least partially completed by the consumer management portal 414, as discussed herein. Alternatively, selecting the link directs the web browser directly to an order form without showing search results. The comparison 718 may include indicia 720 of one or more of the vendors that are offering the identified consumables 714 at the lowest price (e.g., vendor B in this example). In another embodiment, actual prices may be displayed next to the respective vendor names.

As discussed above, the user interface 700 also displays consumable levels 722 for the identified consumables 714. As shown in this example, the consumable levels 722 may be represented as a percentage of respective consumables remaining in the identified office machines 710. In one embodiment, the user interface 700 also displays available local inventory 724 for the identified consumables 714. Thus, the user can quickly verify whether a particular consumable in an office device can be replaced from the local inventory or whether a replacement must be ordered. The user can also decide whether to order consumables for the local inventory. The user interface 700 allows the user to select a button 726 to edit the local inventory. In one embodiment, the local inventory is monitored and consumables are automatically or semi-automatically re-ordered to replenish the local inventory.

In addition to reordering the identified consumables 714 (e.g., consumables having levels that are automatically monitored), the user interface 700 also allows the user to select a button 728 to manually identify and order additional consumables. For example, the user may decide to order additional consumables for the identified office machines 710 to keep in the local inventory until needed. As another example, the user may decide to order consumables for other office machines that are not being monitored. Further, the user may decide to order other office supplies that are not used by office machines.

In one embodiment, the user interface 700 includes a button 730 to allow the user to edit user preferences. The user preferences may include, for example, name, password, address, credit card information, account information, preferred shipping method, or combinations of the foregoing. Thus, the user preferences allow the user to generate future orders without the need to re-enter the user's information for each order.

The user interface 700 also includes a button 732 that allows the user to edit vendor preferences. Thus, the user can specify a list of preferred vendors to search for offered consumables. The user can also create a “black list” of vendors that the user prefers not to search or display. The user interface 700 also includes a button 734 that allows the user to edit consumable preferences. For example, the user can specify a search for manufacturer recommended consumables. Alternatively, the user can specify a search for refurbished consumables.

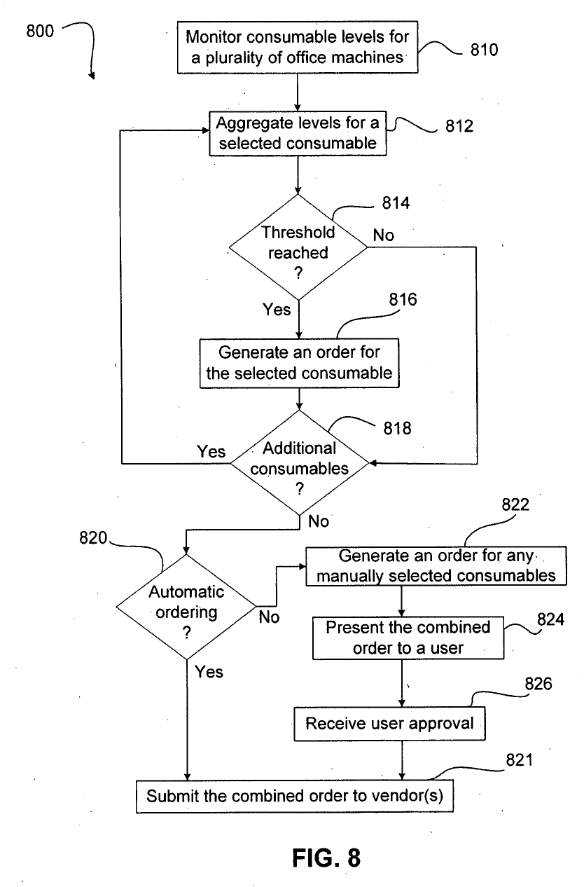

FIG. 8 is a flowchart of a method 800 for ordering a plurality of consumables according to one embodiment. The method 800 includes monitoring 810 consumable levels for a plurality of office machines. The method 800 continues by aggregating 812 levels for a selected consumable. In one embodiment, the selected consumable is for a subset of monitored office machines. For example, a user system may include a subset of laser printers that use a particular toner and a subset of ink jet printers that use a particular ink cartridge. Another subset of office machines comprising the subset of laser printers and the subset of ink jet printers may use a particular paper. The method 800 allows the user system to separately monitor the toner, the ink cartridges and the particular paper, and generate a combined order for these consumables.

The method 800 also includes determining 814 whether the aggregate level for the selected consumable is at or below a threshold level. The threshold may be set by a user. Alternatively, the system may automatically set the level based on historical usage. If the level for the selected consumable is at or below the threshold level, the method 800 generates 816 an order for the selected consumable.

FIG. 9 is a block diagram of an exemplary data structure 900 of an order for consumables according to one embodiment. The exemplary data structure 900 includes a vendor ID 910, a consumable ID 912, billing information 914, and delivery information 916. The vendor ID 910 uniquely identifies a vendor or vendor site offering the selected consumable. The consumable ID 912 uniquely identifies the selected consumable being ordered. The billing information 914 includes account information, credit card information, or other payment information such as details and authorization for payment through an online payment service or online escrow service. The delivery information 916 includes address information, preferred carrier information, and other delivery details.

Returning to FIG. 8, after generating the order for the selected consumable, the method 800 queries 818 whether there are additional consumables being monitored. If there are additional consumables, the method returns to step 812 so as to aggregate levels for the next selected consumable. Thus, the method 800 may create a combined order for a plurality of consumables (e.g., toner, ink cartridges, particular paper, etc.). FIG. 10, for example, is a block diagram of an exemplary data structure 1000 for a plurality of orders (Order A, Order B, Order C, . . . ,Order N) of consumables according to one embodiment. As shown in FIG. 10, the data structure 1000 comprises a combined order that may include separate orders for different types of consumables from different vendors and/or manufacturers.

Returning to FIG. 8, if there are no additional consumables, the method 800 queries 820 whether the system is configured for automatic ordering. If the system is configured for automatic ordering, the system submits 821 the combined order to one or more selected vendor without user intervention. If the system is not configured for automatic ordering, the method 800 generates 822 an order for manually selected consumables, if any. Thus, the system allows the user to specify quantities or different types of consumables. The system then presents 824 the combined order to the user for review. After receiving 826 user approval, the system submits 821 the combined order to the one or more selected vendors.

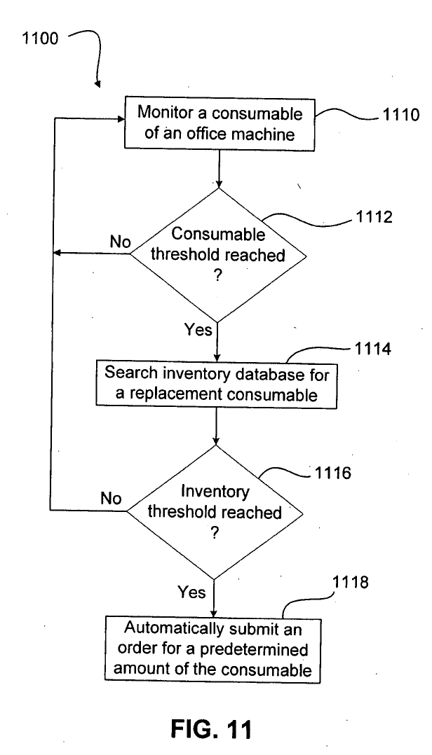

FIG. 11 is flowchart of a method 1100 for replenishing a local consumable inventory according to one embodiment. The method 1100 includes monitoring 1110 a consumable of an office machine and querying 1112 whether a consumable threshold has been reached. If the consumable level is at or below the consumable threshold, the method 1100 searches 1114 an inventory database for a replacement consumable. After, determining that the local database includes the replacement consumable, the method 1100 queries 1116 whether removing the replacement consumable from the local inventory will cause the local inventory of the consumable to drop to or below an inventory threshold. If the inventory threshold is reached, the method 1100 automatically submits 1118 an order for a predetermined amount of the consumable to replenish the local inventory.

An artisan will recognize from the disclosure herein that the method 1100 shown in FIG. 11 may be combined, for example, with the method 800 shown in FIG. 8. For example, the order to replenish the local inventory may be presented to and approved by the user before being submitted to one or more vendors.

While specific embodiments and applications of the disclosure have been illustrated and described, it is to be understood that the disclosure is not limited to the precise configuration and components disclosed herein. For example, in one embodiment, the consumable comprises a memory card, such as those used with digital cameras, for storing digital documents (e.g., digital photographs, graphics, text documents, etc.). Such memory devices may be removably inserted in a memory or communication port of a computer, printer, or other office machine, to print one or more digital documents stored thereon. In one embodiment, the systems and methods described herein monitor the available storage space and/or the useful life remaining in the memory card. If the storage space and/or the remaining useful life fall to or below a predetermined level, the systems and methods described herein may automatically direct a web browser to a website for ordering a replacement memory card.

As another example, in one embodiment, inserting a memory card into a communication port of a printer or computer for printing a digital document thereon may cause the system to determine that there are not enough consumables available to adequately print the document or that printing the document will cause a consumable level to fall below a threshold level. In such an embodiment, the systems and methods described herein may automatically direct a web browser to a website for ordering replacement consumables (e.g., toner, ink, paper, etc.).

As the above examples demonstrate, various modifications, changes, and variations apparent to those of skill in the art may be made in the arrangement, operation, and details of the methods and systems of the disclosure without departing from the spirit and scope of the disclosure.

What is claimed is:

1. A method for ordering consumables, comprising:
monitoring, through a network, consumable levels for a plurality of office machines;
detecting that a first consumable for a first subset of the office machines is at or below a first threshold level;
detecting that a second consumable for a second subset of the office machines is at or below a second threshold level; and
automatically generating a combined order for the first and second consumables.

2. The method of claim 1, further comprising:
automatically submitting the order to a vendor without user intervention.

3. The method of claim 1, further comprising:
allowing a user to approve the order and submit the approved order to a vendor.

4. The method of claim 1, wherein the first and second consumables are of different types.

5. The method of claim 4, wherein at least one type of consumable comprises ink or toner.

6. The method of claim 4, wherein at least one type of consumable comprises staples.

7. The method of claim 4, wherein at least one type of consumable comprises paper.

8. The method of claim 1, further comprising:
storing the consumable levels for the plurality of office machines;
allowing a user to view a summary of the stored consumable levels.

9. The method of claim 8, further comprising:
allowing the user to selectively place an order for one or more consumables for a third subset of office machines.

10. The method of claim 8, further comprising:
storing an inventory for office supplies in addition to the consumable levels for the plurality of office machines;
allowing the user to view the office supply inventory in conjunction with the summary of the stored consumable levels; and
allowing the user to selectively place a combined order for additional office supplies and one or more consumables for a third subset of office machines.

11. The method of claim 1, wherein the first threshold level is specified by a user.

12. The method of claim 1, wherein the first threshold level is automatically determined based on historical usage patterns.

13. The method of claim 1, wherein automatically generating a combined order comprises:
automatically directing a web browser to a consumable ordering site.

14. The method of claim 13, wherein the consumable ordering site provides a comparison of prices for the first and second consumables from a plurality of vendors and allows a user to select one of the vendors to fulfill the order.

15. The method of claim 1, wherein automatically generating a combined order comprises:
automatically adding indications of the first and second consumables to the order.

16. The method of claim 15, wherein automatically adding indications of the first and second consumables to the order comprises:
automatically adding indications of the first and second consumables to a shopping cart without user intervention.

17. The method of claim 1, wherein automatically generating a combined order comprises:
automatically adding billing information to the order.

18. The method of claim 1, wherein automatically generating a combined order comprises:
automatically adding delivery information to the order.

19. The method of claim 1, wherein automatically generating a combined order comprises:
automatically adding indications of the first and second consumables to the order;
automatically adding billing information to the order;
automatically adding delivery information to the order; and
allowing a user to submit the order to a vendor with a single action.

20. The method of claim 1, wherein at least one office machine is selected from the group consisting of a printer, a copier, and a fax machine.

21. A system for ordering consumables, comprising:
a monitoring subsystem to monitor, through a network, consumable levels for a plurality of office machines;
a detection subsystem to detect that a first consumable for a first subset of the office machines is at or below a first threshold level and that a second consumable for a second subset of the office machines is at or below a second threshold level; and
an order generating subsystem to automatically generate a combined order for the first and second consumables.

22. The system of claim 21, wherein the order generating subsystem is to automatically submit the order to a vendor without user intervention.

23. The system of claim 21, wherein the order generating subsystem is to allow a user to approve the order and submit the approved order to the vendor.

24. The system of claim 21, further comprising:
a web portal to store the consumable levels for the plurality of office machines and allow a user to view a summary of the stored consumable levels.

25. The system of claim 24, wherein the web portal is further to allow the user to selectively place an order for one or more consumables for a third subset of office machines.

26. The system of claim 24, wherein the web portal is further to store an inventory for office supplies in addition to the consumable levels for the plurality of office machines, allow the user to view the office supply inventory in conjunction with the summary of the stored consumable levels, and allow the user to selectively place a combined order for additional office supplies and one or more consumables for a third subset of office machines.

27. The system of claim 21, wherein the first threshold level is specified by a user.

28. The system of claim 21, wherein the first threshold level is automatically determined based on historical usage patterns.

29. The system of claim 21, wherein the order generating subsystem is to automatically direct a web browser to a consumable ordering site.

30. The system of claim 29, wherein the consumable ordering site provides a comparison of prices for the first and second consumables from a plurality of vendors and allows a user to select one of the vendors to fulfill the order.

31. The system of claim 29, wherein the order generating subsystem is to automatically add indications of the first and second consumables to a shopping cart, automatically add billing information to the order, automatically add delivery information to the order; and allow a user to submit the order to a vendor with a single action.

32. A web portal for ordering consumables, comprising:
an aggregation component for combining information received through a network regarding consumable levels for a plurality of office machines;
a notification component for displaying a summary of the consumable levels to a user;
a comparison component for listing prices from a number of different vendors for additional quantities of the consumables; and
a ordering component for allowing the user to place a combined order for the consumables used by at least two different office machines.

33. The web portal of claim 32, further comprising:
a detection component for detecting that a first consumable for a first subset of the office machines is at or below a threshold level, and wherein the ordering component is to automatically add an indication of the first consumable to the order.

34. A method for ordering consumables, comprising:
detecting that a consumable in an office machine has been depleted below a predetermined level;
identifying a plurality of websites offering the consumable;
simultaneously displaying indicia of the plurality of websites offering the consumable to a user through a user interface;
allowing the user to select a website from the plurality of websites from which to order the consumable; and
automatically generating an order for the consumable from the selected website.

35. The method of claim 34, wherein the predetermined level is specified by the user.

36. The method of claim 34 wherein the predetermined level is automatically determined based on historical usage patterns.

37. The method of claim 34, wherein identifying the plurality of websites comprises:
automatically searching the Internet for vendors offering the consumable; and
determining a price offered for the consumable by each of the plurality of websites.

38. The method of claim 37, wherein the indicia includes the respective prices.

39. The method of claim 37, wherein the indicia includes an indication of a lowest offered price.

40. The method of claim 34, wherein the indicia includes a plurality of links to the respective plurality of websites.

41. The method of claim 40, wherein allowing the user to select the website from the plurality of websites comprises allowing the user to select the respective link.

42. The method of claim 34, wherein automatically generating the order comprises:
opening a web browser;
directing the web browser to the selected website, the selected website having an order form; and
at least partially completing the order form with information regarding the consumable.

43. The method of claim 42, further comprising at least partially completing the form with at least one of shipping information and billing information.

44. The method of claim 34, wherein automatically generating the order comprises automatically adding indications of the consumable to an online shopping cart without user intervention.

45. The method of claim 34, further comprising graphically displaying a level of the consumable along with the indicia of the plurality of websites on the user interface.

46. The method of claim 34, further comprising allowing the user to selectively order additional consumables through the user interface, at least one of the additional consumables being incompatible with the office machine.

47. The method of claim 34, further comprising allowing the user to specify one or more preferred vendors through the user interface.

48. A method for replenishing a local inventory of consumables, comprising:
monitoring, through a network, a consumable for an office machine;
detecting that the consumable is at or below a first threshold level;
searching a database of available inventory for a replacement for the consumable;
determining whether, after removing the replacement consumable from the available inventory, the available inventory is at or below a second threshold level; and
if the available inventory is at or below the second threshold level, automatically submitting an order for a predetermined amount of the consumable.

49. The method of claim 48, wherein automatically submitting the order comprises:
completing an order form for the consumable; and
submitting the order form to an online vendor without user intervention.

50. The method of claim 48, wherein automatically submitting the order form comprises:
at least partially completing an order form for the consumable; and
presenting the order form to a user for authorization.

51. The method of claim 48, wherein at least one of the first threshold level and the second threshold level is specified by a user.

52. The method of claim 48, wherein at least one of the first threshold level and the second threshold level is determined based on historical usage patterns.

53. A method for ordering consumables, the method comprising:
monitoring a consumable level of an office machine; and
upon detecting that the consumable level is at or below a threshold level, automatically directing a web browser to a consumable ordering site.

54. The method of claim 53, further comprising automatically adding indications of the consumable to an order in the consumable ordering site.

55. The method of claim 54, further comprising automatically submitting the order to the consumable ordering site without user intervention.

56. The method of claim 54, further comprising allowing a user to approve the order and submit the order to the consumable ordering site.

57. The method of claim 54, wherein automatically adding indications of the consumable to the order comprises automatically adding the consumable to an online shopping cart without user intervention.

58. The method of claim 57, further comprising allowing a user to selectively submit the shopping cart to the consumable ordering site for purchase.

59. The method of claim 57, further comprising allowing a user to add additional consumables to the shopping cart before submitting the shopping cart to the consumable ordering site for purchase.

60. The method of claim 54, wherein automatically adding indications of the consumable to the order comprises automatically adding billing information to the order.

61. The method of claim 54, wherein automatically adding indications of the consumable to the order comprises automatically adding delivery information to the order.

62. The method of claim 53, wherein the threshold level is specified by a user.

63. The method of claim 53, wherein the threshold level is automatically determined based on historical usage patterns.

64. The method of claim 53, wherein the consumable ordering site provides a comparison of prices for the consumable from a plurality of vendors and allows a user to select one of the vendors to fulfill an order.
